(19) United States
(12) Patent Application Publication
(10) Pub. No.: US 2026/0341795 A1
(43) Pub. Date: Oct. 29, 2026

(54) BATTERY CELL AND METHOD FEATURING A SOLID ELECTROLYTE INTERPHASE LAYER ENABLING REVERSIBLE LITHIUM METAL CYCLING FOR ENHANCED FAST-CHARGING STABILITY

(71) Applicant: GM Global Technology Operations LLC, Detroit, MI (US)

(72) Inventors: Xin Zhang, Shanghai (CN); Dewen Kong, Shanghai (CN); Haijing Liu, Shanghai (CN)

(21) Appl. No.: 19/197,196

(22) Filed: May 2, 2025

(30) Foreign Application Priority Data
Apr. 28, 2025 (CN) 202510549951.2

(51) Int. Cl. H01M 10/058; H01M 4/02; H01M 4/04; H01M 4/1393; H01M 4/1395; H01M 4/1397; H01M 4/38; H01M 4/58; H01M 4/583; H01M 10/056; H01M 10/44; H01M 50/105; H01M 50/431; H01M 50/46

(52) U.S. Cl. CPC H01M 10/058; H01M 4/0404; H01M 4/1393; H01M 4/1395; H01M 4/1397; H01M 4/386; H01M 4/5825; H01M 4/583; H01M 10/056; H01M 10/44; H01M 50/105; H01M 50/431; H01M 50/46; H01M 2004/027; H01M 2004/028; H01M 2220/20; H01M 2300/0068

(57) ABSTRACT

A vehicle battery cell, a vehicle, and a method for forming the battery cell is provided. The vehicle battery cell includes an anode current collector, an anode disposed on the anode current collector, a solid-electrolyte interphase layer disposed on the anode, a separator disposed on the solid-electrolyte interphase layer, a cathode disposed on the separator, and a cathode current collector disposed on the cathode. The separator includes lithium nitride (Li₃N), and the lithium nitride (Li₃N) induces uniform lithium deposition on the anode.

### INTRODUCTION

The present disclosure relates to a battery cell, and more particularly, to a battery cell with a solid-electrolyte interphase layer.

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides a source of lithium ions and determines capacity and average voltage of a battery. The anode stores and releases lithium ions received from the cathode when energy is needed. The separator prevents the cathode and anode from contacting and shorting out the battery, and the electrolyte provides a medium between the cathode and anode through which the lithium ions travel. Electric vehicle charge time is an important factor in electric vehicles. Extreme fast chargeable battery cells have potential to significantly reduce charge time.

Thus, while present battery chemistries achieve their intended purpose, there is a need for new and improved battery chemistries that offer improved stability and better cyclability.

### SUMMARY

According to several aspects of the present disclosure, a vehicle battery cell is provided. The vehicle battery cell includes an anode current collector, an anode disposed on the anode current collector, a solid-electrolyte interphase layer disposed on the anode, a separator disposed on the solid-electrolyte interphase layer, a cathode disposed on the separator, and a cathode current collector disposed on the cathode. The separator includes lithium nitride (Li₃N), and the lithium nitride (Li₃N) induces uniform lithium deposition on the anode.

In accordance with another aspect of the disclosure, the anode includes at least one of graphite, silicon carbide (SiC), or silicon oxide (SiOₓ).

In accordance with another aspect of the disclosure, the cathode includes at least one of lithium cobalt oxide (LCO), lithium nickel manganese cobalt oxide (NMC), lithium nickel cobalt aluminum oxide (NCA), lithium iron phosphate (LFP), or lithium manganese oxide (LMO).

In accordance with another aspect of the disclosure, the cathode includes lithium iron phosphate (LFP) and the anode includes graphite.

In accordance with another aspect of the disclosure, the cathode includes lithium iron phosphate (LFP) and the anode includes a graphite and silicon-carbon composite anode.

According to several aspects of the present disclosure, a vehicle is provided. The vehicle includes a plurality of battery cells assembled together. Each battery cell includes an anode current collector, an anode disposed on the anode current collector, a solid-electrolyte interphase layer disposed on the anode, a separator disposed on the solid-electrolyte interphase layer, a cathode disposed on the separator, and a cathode current collector disposed on the cathode. The separator includes lithium nitride (Li₃N), and the lithium nitride (Li₃N) induces uniform lithium deposition on the anode.

In accordance with another aspect of the disclosure, the anode includes at least one of graphite, silicon carbide (SiC), or silicon oxide (SiOₓ).

In accordance with another aspect of the disclosure, the cathode includes lithium iron phosphate (LFP) and the anode includes graphite.

In accordance with another aspect of the disclosure, the cathode includes lithium iron phosphate (LFP) and the anode includes a graphite and silicon-carbon composite anode.

In accordance with another aspect of the disclosure, the battery is a pouch cell.

According to several aspects of the present disclosure, a method for forming a battery cell is provided. The method for forming the battery cell includes applying a cathode to a cathode current collector, applying an anode to an anode current collector, positioning a separator between the cathode and the anode, assembling the cathode, the anode, and the separator into a battery cell housing, adding an electrolyte into the battery cell housing, sealing the battery cell housing, and charging and discharging the battery cell during formation causing a uniform bulk deposited solid-electrolyte interphase (SEI) layer to form on a surface of the anode. The electrolyte contacts the cathode, the anode, and the separator, and the electrolyte includes at least one of a lithium-based additive, a nitrate salt, or a nitrite salt. The at least one of the lithium-based additive, the nitrate salt, or the nitrite salt promotes formation of the solid-electrolyte interphase (SEI) layer, and the solid-electrolyte interphase (SEI) layer includes lithium nitride (Li₃N).

In accordance with another aspect of the disclosure, wherein the nitrate salt is lithium nitrate (LiNO₃).

In accordance with another aspect of the disclosure, a concentration of the lithium nitrate (LiNO₃) is between 0.2-2.0 weight percent (wt. %).

In accordance with another aspect of the disclosure, the nitrate salts include at least one of potassium nitrate (KNO₃), sodium nitrate (NaNO₃), tetramethylammonium nitrate ((CH₃)₄N⁺NO₃⁻), tetraethylammonium nitrate ((C₂H₅)₄N⁺NO₃⁻), tetramethylammonium nitrate ((C₃H₇)₄N⁺NO₃⁻), or isosorbide dinitrate (C₆H₈N₂O₈).

In accordance with another aspect of the disclosure, the nitrite salts include at least one of lithium nitrite (LiNO₂), sodium nitrite (NaNO₂), or potassium nitrite (KNO₂).

In accordance with another aspect of the disclosure, the electrolyte is a suspension electrolyte including lithium (Li₃N) nanoparticles.

In accordance with another aspect of the disclosure, the nanoparticles have a size between 10-500 nanometers (nm).

In accordance with another aspect of the disclosure, the electrolyte includes lithium hexafluorophosphate (LiPF₆) and lithium bis(fluorosulfonyl)imide (LiFSI) having lithium nitrate at a concentration of 0.5 weight percent (wt. %).

In accordance with another aspect of the disclosure, the liquid electrolyte includes lithium hexafluorophosphate (LiPF₆) and lithium bis(fluorosulfonyl)imide (LiFSI) having lithium nitrate at a concentration of 0.6 weight percent (wt. %).

In accordance with another aspect of the disclosure, the charging and discharging includes 100% extreme fast charging (XFC).

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having an electric motor powered by a battery pack with a solid electrolyte interphase layer that promotes uniform lithium (Li) deposition, in accordance with the present disclosure.

FIG. 2 is a cross section schematic view of a battery cell in the battery pack in the vehicle shown in FIG. 1, in accordance with the present disclosure.

FIG. 3 is a cross section schematic view illustrating a battery cell in the battery pack in the vehicle shown in FIG. 1, where the battery cell includes a solid electrolyte interphase layer that promotes uniform lithium (Li) deposition, in accordance with the present disclosure.

FIG. 4 is a flowchart illustrating a method for forming the battery cell shown in FIG. 3, where the battery cell includes a solid electrolyte interphase layer that promotes uniform lithium (Li) deposition, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

Fast-charging capability of power batteries is becoming increasingly important. Although many batteries have capabilities of a charging rate of 8 C or 10 C in one cycle, performance deteriorates rapidly under 100% extreme fast-charging cycles due at least partially to a lithium (Li) precipitation issue. By leveraging a solid electrolyte interphase layer that promotes uniform lithium (Li) deposition, the vehicle battery cell disclosed herein leads to improve lithium (Li) reversibility and overall battery cell performance under demanding charging conditions.

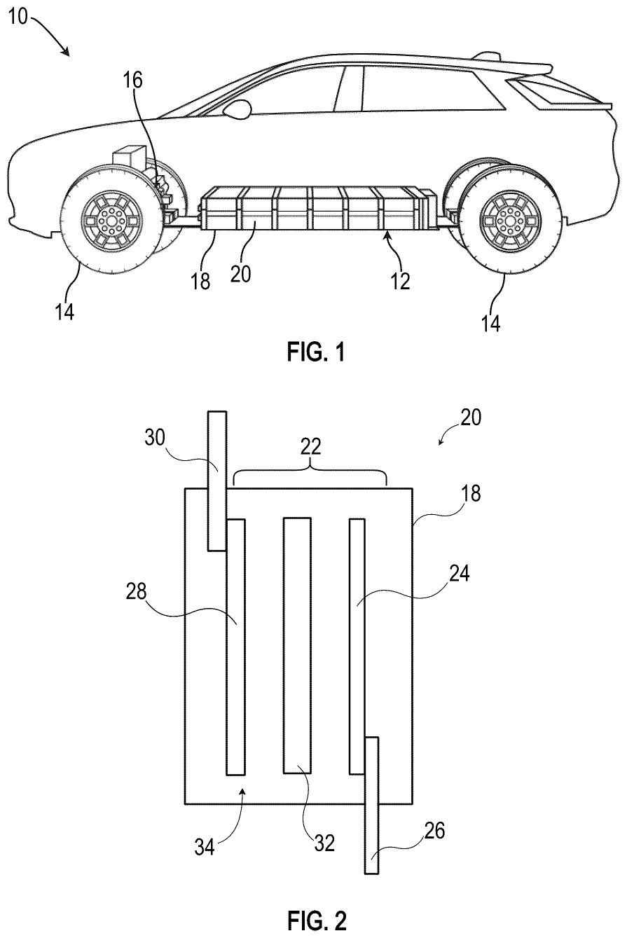

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. The battery pack 12 includes a housing 18 for carrying and supporting a plurality of battery cells 20. In an example, the battery pack 12 may have fifty or more battery cells 20.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

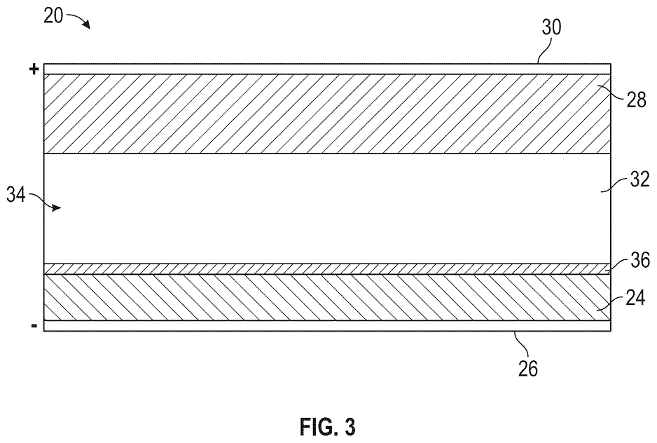

FIGS. 2 and 3 illustrate one battery cell 20 within the battery pack 12 illustrated in FIG. 1. The battery pack 12 and the battery cells 20 are understood to be rechargeable batteries that may be discharged upon application of a load and recharged upon the application of an external power source. The battery cells 20 may be, for example, a pouch cell or prismatic cell. Alternatively, the battery cells 20 may be cylindrical-style cells.

Each battery cell 20 disposed within the battery pack 12 shown in FIG. 1 has at least one electrode stack 22, which further includes an anode 24 disposed on an anode current collector 26, a cathode 28 disposed on a cathode current collector 30, and a separator 32 that separates the anode 24 and the cathode 28. Each battery cell 20 may have tens or hundreds of electrode stacks 22.

The electrode stacks 22 are placed in the housing 18, which are filled with an electrolyte 34. During electrical discharge, when a load is applied to the battery cells 20, Li+ ions move from the anode 24 to the cathode 28 through the separator 32 by way of the electrolyte 34. Equivalent electrons (e⁻) move through battery circuitry from the cathode 28 to the anode 24, providing energy to a battery load. While charging and upon application of an external voltage, (Li⁺) ions move from the cathode 28 to the anode 24 by way of the electrolyte 34 through the separator 32 and may be intercalated into the anode 24.

While the illustrated battery cells 20 are shown as including one anode 24 (and anode current collector 26) and one cathode 28 (and one cathode current collector 30), the battery cell 20 may alternatively include two or more cathodes 28 (and cathode current collectors 30) and one or more anodes 24 (and anode current collectors 26). In further alternative embodiments, the battery cell 20 may include one or more cathodes 28 (and cathode current collectors 30) and two or more anodes 24 (and anode current collectors 26).

The anode current collector 26 may be a thin metal plate or foil disposed on a side of each electrode stacks 22 and/or housing 18 and may typically have a thickness between 0.005 and 1 millimeter. The anode current collector 26 may be made of copper or aluminum, for example, and attached to the electrode stacks 22 to transmit the electric current to an external circuit (not shown). In other examples, the anode current collector 26 may include copper clad aluminum, nickel, titanium, stainless steel, and/or other suitable materials. While the anode current collector 26 is illustrated as being in the form of a foil, it will be appreciated that other forms may be exhibited, such as mesh or a composite-type material.

Still referring to FIGS. 2 and 3, the anode 24 is disposed on the anode current collector 26 and includes materials that undergo reversible insertion or intercalation of lithium ions at a lower electrochemical potential than the cathode 28 such that an electrochemical potential difference exists between the anode 24 and cathode 28. The anode 24 may include one or more of carbon based materials, for example graphite, activated carbon, carbon black and graphene, silicon, silicon carbide (SiC), a graphite and silicon-carbon composite, silicon based alloys, silicon oxide, silicon based composite materials, tin oxide, aluminum, indium, zinc, germanium, and/or titanium oxide, as well as any combination of the above. In one example, the anode 24 does not include lithium (Li). In embodiments, the anode 24 may exhibit a thickness in the range of 10 micrometers to 200 micrometers including all values and ranges therein.

Referring to FIG. 3, an example of the vehicle battery cell 20 is shown. In this example, a solid-electrolyte interphase (SEI) layer 36 is disposed on the anode 24. The SEI layer 36 includes a Li₃N component. The solid-electrolyte interphase layer 36 is formed during initial charge cycles and includes decomposition products from the electrolyte 34.

Referring to FIGS. 2 and 3, the electrolyte 34 provides a medium between the cathode 28 and anode 24 through which lithium ions travel. The medium may be a liquid, gel and is capable of conducting the lithium ions between the cathode 28 and the anode 24. The electrolyte 34 permeates the pores of the porous separator 32 and wets or otherwise contacts the surfaces of the cathode 28 and anode 24 as well as the separator 32. In embodiments, the electrolyte 34 includes one or more lithium salts dissolved in non-aqueous organic solvent. Some example of lithium salts may include one or more of lithium hexafluorophosphate (LiPF6), lithium perchlorate (LiClO4), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl) imide (LiN(F_{S}O₂)₂) (LiSFI), lithium (triethylene glycol dimethy 1 ether)bis(trifluoromethanesulfonyl)imide (Li(G₃)(TFSI), and/or lithium bis(trifluoromethanesulfonyl)azanide (LiTFSA). In an example, the electrolyte is a liquid electrolyte including lithium hexafluorophosphate (LiPF₆) and lithium bis(fluorosulfonyl)imide (LiFSI) having lithium nitrate at a concentration of 0.5 weight percent (wt. %). In an example, the electrolyte is a liquid electrolyte including lithium hexafluorophosphate (LiPF₆) and lithium bis(fluorosulfonyl)imide (LiFSI) having lithium nitrate at a concentration of 0.6 weight percent (wt. %).

The SEI layer 36 with Li₃N can be formed by adding nitrate salts, nitrite salts, and/or lithium nitride to the electrolyte 34 in an amount sufficient to promote formation of a uniform and bulk-like lithium deposition morphology on the anode 24 when charging with extreme fast-charging cycles. An extreme fast charging (XFC) cycle refers to a process of rapidly charging a battery, for example aiming to charge up to 80% of the battery capacity within a very short time frame (e.g., 10-15 minutes). This is particularly relevant for electric vehicles (e.g., vehicle 10), where reducing charging time is crucial for convenience and wider adoption.

Some example nitrate salts suitable for addition to the electrolyte 34 may include lithium nitrate (LiNO₃), potassium nitrate (KNO₃), sodium nitrate (NaNO₃), tetramethylammonium nitrate ((CH₃)₄N⁺NO₃⁻), tetraethylammonium nitrate ((C₂H₅)₄N⁺NO₃⁻), tetramethylammonium nitrate ((C₃H₇)₄N⁺NO₃⁻), and/or isosorbide dinitrate (C₆H₈N₂O₈). In one example where lithium nitrate (LiNO₃) is used, a concentration of the lithium nitrate (LiNO₃) is between 0.2-2.0 weight percent (wt. %). Some examples of nitrite salts suitable for addition to the electrolyte 34 may include lithium nitrite (LiNO₂), sodium nitrite (NaNO₂), and/or potassium nitrite (KNO₂). When a suspension electrolyte is used, the suspension electrolyte may include lithium nitride (Li₃N) nanoparticles. The nanoparticles may have a size between 10-500 nanometers (nm). When Li₃N is generated in-situ in the SEI layer 36 using an addition of a nitrate salt or a nitrite salt, the Li₃N generated may have a smaller size and a more uniform distribution.

The uniform and bulk-like lithium deposition morphology formed using the nitrate salts, the nitrite salts, and/or the suspension electrolyte can be characterized by a reduced propensity for whisker-like lithium growth compared to a cell that have SEI layer without Li₃N components and results in improved reversibility of lithium plating and stripping during XFC cycles.

As shown in FIG. 3, the separator 32 is disposed on the SEI layer 36. The separator 32 may be a porous material formed of an electrically insulative material that prevents the cathode 28 and the anode 24 from contacting and potentially shorting out the battery circuit. The separator 32 is sandwiched, or at least partially enclosed, between the cathode 28 and anode 24 allowing the passage of the lithium ions and electrolyte 34 through the pores of the separator 32. The separator 32 may include one or more of a composite material, a polymeric material, or a non-woven material. In any of the designs above, one or more separators 32 are interleaved between the cathodes 28 and anodes 24 to prevent the cathodes 28 and the anodes 24 from contacting. In embodiments, the separator 32 includes at least one of polyethylene, polypropylene, polyamide, polytetrafluoroethylene, polyvinylidene fluoride, and polyvinyl chloride. Additionally, the separator 32 may be filled, i.e., include fillers dispersed therein, wherein the filler includes a material such as glass fiber. In additional or alternative embodiments, the separator 32 may include at least one of a thermally stable, porous polymer coating and a ceramic coating such as an alumina coating. The coating may be disposed on one or more surfaces of a porous polymer film, which may include at least one of polyethylene and polypropylene. The separator 32 may include one or more layers, wherein each layer is formed from one or more of the materials noted above. The separator 32 may take the form of film or a mesh, such as woven mesh or a slit film. In embodiments, the separator 32 exhibits a thickness in the range of 4 micrometers to 25 micrometers, including all values and ranges therein.

As shown in FIGS. 2 and 3, the cathode 28 is disposed on the separator 32. The cathode 28 may include a cathode active material configured to provide a source of lithium ions (Li⁺) and undergo reversible insertion or intercalation of lithium ions determining, for example, the capacity and average voltage of a battery. The cathode active material may include lithium iron phosphate (LFP), for example. In other examples, the cathode 28 may include at least one of lithium cobalt oxide (LCO); lithium nickel manganese cobalt oxide (NMC); lithium nickel cobalt aluminum oxide (NCA); or lithium manganese oxide (LMO). It will be appreciated that the cathode 28 may include other market-available materials as well.

As shown in FIGS. 2 and 3, the cathode current collector 30 is disposed on the cathode 28. The cathode current collector 30 may be a thin metal plate or foil disposed on a side of each electrode stacks 22 and/or housing 18 and may typically have a thickness between 0.005 and 1 millimeter. The cathode current collector 30 may be made of copper or aluminum, for example, and are attached to the electrode stacks 22 to transmit the electric current to an external circuit (not shown).

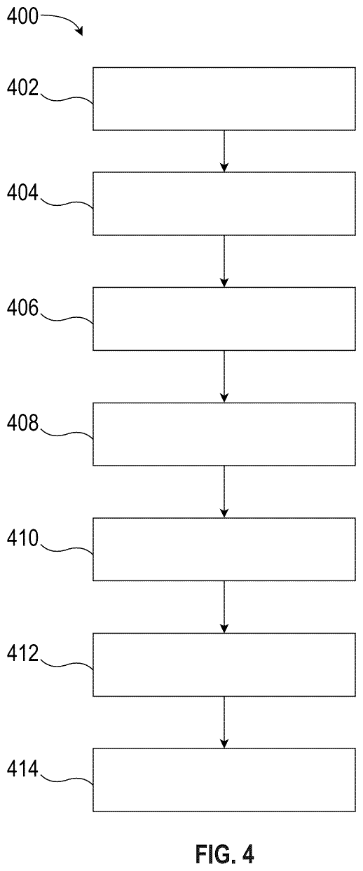

FIG. 4 illustrates a method 400 for forming a battery cell shown in FIGS. 2 and 3. The method 400 begins at step 402.

Step 402 depicts applying the cathode 28 to the cathode current collector 30. The cathode material, often a mixture of active materials, binders, and conductive additives, is prepared in a slurry form. The slurry is then uniformly coated onto the cathode current collector 30. The slurry can then be dried to remove solvents and ensure the cathode material adheres well to the cathode current collector 30. The dried slurry forms the cathode 28, which may then be calendared.

Step 404 depicts applying the anode 24 to an anode current collector 26. The anode material, often a mixture of active materials (e.g., graphite), binders, and conductive additives, is prepared in a slurry form. The slurry is then uniformly coated onto the anode current collector 26. The slurry can then be dried to remove solvents and ensure the anode material adheres well to the anode current collector 26. The dried slurry forms the anode 24, which may then be calendared.

Step 406 depicts positioning the separator 32 between the cathode 28 and the anode 24. Step 408 depicts assembling the cathode 28, the anode 24, and the separator 32 into a battery cell housing 18. The positioning and assembling steps may be performed using stacking or winding machines.

Step 410 depicts adding an electrolyte 34 into the battery cell housing 18. The electrolyte 34 contacts the cathode 28, the anode 24, and the separator 32. The electrolyte 34 includes at least one of a lithium-based additive, a nitrate salt, or a nitrite salt. The electrolyte 34 may be added into the battery cell housing using an electrolyte filling machine. Step 412 depicts sealing the battery cell housing 18. The battery cell housing 18 may be sealed using a sealing machine.

Step 414 depicts charging and discharging the battery cell 20 during formation causing a uniform bulk deposited solid-electrolyte interphase (SEI) layer 36 to form on a surface of the anode 24. The at least one of the lithium-based additive, the nitrate salt, or the nitrite salt promotes formation of the solid-electrolyte interphase (SEI) layer 36, and the solid-electrolyte interphase (SEI) layer 36 includes lithium nitride (Li₃N). Charging and discharging the battery cell 20 may be performed using a formation tester and/or aging cabinets.

The vehicle battery cell 20 and method 400 of the present disclosure is advantageous and beneficial over prior art. By leveraging the solid electrolyte interphase layer 36, which promotes uniform lithium (Li) deposition on the anode 24, the vehicle battery cell 20 disclosed herein leads to improve lithium (Li) reversibility and overall battery cell performance under demanding charging conditions.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle battery cell, comprising:
an anode current collector;
an anode disposed on the anode current collector;
a solid-electrolyte interphase layer disposed on the anode;
a separator disposed on the solid-electrolyte interphase layer, wherein the separator includes lithium nitride (Li₃N), and wherein the lithium nitride (Li₃N) induces uniform lithium deposition on the anode;
a cathode disposed on the separator; and
a cathode current collector disposed on the cathode.

2. The vehicle battery cell of claim 1, wherein the anode includes at least one of graphite, silicon carbide (SiC), or silicon oxide (SiOₓ).

3. The vehicle battery cell of claim 1, wherein the cathode includes at least one of lithium cobalt oxide (LCO), lithium nickel manganese cobalt oxide (NMC), lithium nickel cobalt aluminum oxide (NCA), lithium iron phosphate (LFP), or lithium manganese oxide (LMO).

4. The vehicle battery cell of claim 1, wherein the cathode includes lithium iron phosphate (LFP) and the anode includes graphite.

5. The vehicle battery cell of claim 1, wherein the cathode includes lithium iron phosphate (LFP) and the anode includes a graphite and silicon-carbon composite anode.

6. A vehicle, comprising:
a plurality of battery cells assembled together, each battery cell including
an anode current collector;
an anode disposed on the anode current collector;
a solid-electrolyte interphase layer disposed on the anode;
a separator disposed on the solid-electrolyte interphase layer, wherein the separator includes lithium nitride (Li₃N), and wherein the lithium nitride (Li₃N) induces uniform lithium deposition on the anode;
a cathode disposed on the separator; and
a cathode current collector disposed on the cathode.

7. The vehicle in claim 6, wherein the anode includes at least one of graphite, silicon carbide (SiC), or silicon oxide (SiOₓ).

8. The vehicle in claim 6, wherein the cathode includes lithium iron phosphate (LFP) and the anode includes graphite.

9. The vehicle in claim 6, wherein the cathode includes lithium iron phosphate (LFP) and the anode includes a graphite and silicon-carbon composite anode.

10. The vehicle in claim 6, wherein the battery is a pouch cell.

11. A method for forming a battery cell, comprising:
applying a cathode to a cathode current collector;
applying an anode to an anode current collector;
positioning a separator between the cathode and the anode;
assembling the cathode, the anode, and the separator into a battery cell housing;
adding an electrolyte into the battery cell housing, wherein the electrolyte contacts the cathode, the anode, and the separator, wherein the electrolyte includes at least one of a lithium-based additive, a nitrate salt, or a nitrite salt;
sealing the battery cell housing; and
charging and discharging the battery cell during formation causing a uniform bulk deposited solid-electrolyte interphase (SEI) layer to form on a surface of the anode, wherein the at least one of the lithium-based additive, the nitrate salt, or the nitrite salt promotes formation of the solid-electrolyte interphase (SEI) layer, and wherein the solid-electrolyte interphase (SEI) layer includes lithium nitride (Li₃N).

12. The method for forming a battery cell in claim 11, wherein the nitrate salt is lithium nitrate (LiNO₃).

13. The method for forming a battery cell in claim 12, wherein a concentration of the lithium nitrate (LiNO₃) is between 0.2-2.0 weight percent (wt. %).

14. The method for forming a battery cell in claim 11, wherein the nitrate salts include at least one of potassium nitrate (KNO₃), sodium nitrate (NaNO₃), tetramethylammonium nitrate ((CH₃)₄N⁺NO₃⁻), tetraethylammonium nitrate ((C₂H₅)₄N⁺NO₃⁻), tetramethylammonium nitrate ((C₃H₇)₄N⁺NO₃⁻), or isosorbide dinitrate (C₆H₈N₂O₈).

15. The method for forming a battery cell in claim 11, wherein the nitrite salts include at least one of lithium nitrite (LiNO₂), sodium nitrite (NaNO₂), or potassium nitrite (KNO₂).

16. The method for forming a battery cell in claim 11, wherein the electrolyte is a suspension electrolyte including lithium (Li₃N) nanoparticles.

17. The method for forming a battery cell in claim 16, wherein the nanoparticles have a size between 10-500 nanometers (nm).

18. The method for forming a battery cell in claim 11, wherein the electrolyte includes lithium hexafluorophosphate (LiPF₆) and lithium bis(fluorosulfonyl)imide (LiFSI) having lithium nitrate at a concentration of 0.5 weight percent (wt. %).

19. The method for forming a battery cell in claim 11, wherein the liquid electrolyte includes lithium hexafluorophosphate (LiPF₆) and lithium bis(fluorosulfonyl)imide (LiFSI) having lithium nitrate at a concentration of 0.6 weight percent (wt. %).

20. The method for forming a battery cell in claim 11, wherein the charging and discharging includes 100% extreme fast charging (XFC).
